(19) United States
(12) Patent Application Publication
(10) Pub. No.: US 2021/0231844 A1
(43) Pub. Date: Jul. 29, 2021

(54) MULTILAYER REFLECTOR

(71) Applicant: 3M INNOVATIVE PROPERTIES COMPANY, St. Paul, MN (US)

(72) Inventors: Gilles J. Benoit, Minneapolis, MN (US); Matthew B. Johnson, Woodbury, MN (US)

(21) Appl. No.: 17/051,365

(22) PCT Filed: Apr. 29, 2019
(86) PCT No.: PCT/IB2019/053504

§ 371 Date: Oct. 28, 2020

Related U.S. Application Data
(60) Provisional application No. 62/665,947, filed on May 2, 2018.

(51) Int. Cl. G02B 5/08; G02B 5/28

(52) U.S. Cl. CPC G02B 5/0816; G02B 5/287

(57) ABSTRACT

Multilayer reflectors are described. In particular, multilayer reflectors that partially transmit blue light and reflect green and red light are described. The multilayer reflectors have good efficiency and color performance in a backlight including a downconverting material.

### BACKGROUND

Multilayer reflectors are used for many applications, including in displays and lighting applications. Multilayer optical films provide desirable transmission and/or reflection properties at least partially by an arrangement of microlayers of differing refractive index.

### SUMMARY

In one aspect, the present description relates to a multilayer optical reflector. The multilayer optical reflector includes a plurality of optical repeat units, each optical repeat unit having a total optical thickness and including a birefringent polymer and a second polymer and having an f-ratio, defined as the ratio of an optical thickness of the birefringent polymer to the total optical thickness of the optical repeat unit. The plurality of optical repeat units are configured such that a blue hemispheric reflectivity for unpolarized light averaged over the range from 420 to 480 nm is less than 55%, and the plurality of optical repeat units are configured such that a red-green hemispheric reflectivity for unpolarized light averaged over the range from 520 nm to 650 nm is greater than 97%.

### BRIEF DESCRIPTION OF THE DRAWINGS

FIG. 1 is a side elevation cross-section of a multilayer reflector.

FIG. 2A is a side elevation cross-section of a layer pair showing an f-ratio near 50%.

FIG. 2B is a side elevation cross-section of a layer pair showing an f-ratio less than 50%.

FIG. 2C is a side elevation cross-section of a layer pair showing an f-ratio greater than 50%.

FIG. 3 is a side elevation schematic of the operational principles and configurations of a backlight including the multilayer reflector of FIG. 1.

### DETAILED DESCRIPTION

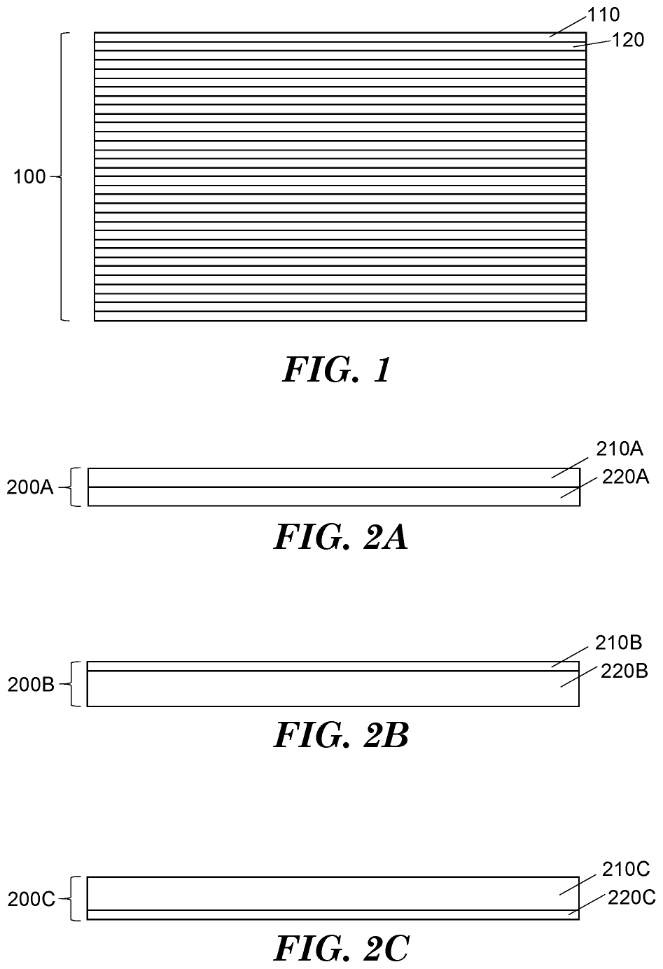

FIG. 1 is a side elevation cross-section of a multilayer reflector with a uniform left bandedge. Multilayer reflector 100 includes alternating high index birefringent layers 112 and low index isotropic layers 114.

Multilayer reflector 100 includes alternating microlayers of at least two different materials. Multilayer optical films, i.e., films that provide desirable transmission and/or reflection properties at least partially by an arrangement of microlayers of differing refractive index, are known. It has been known to make such multilayer optical films by depositing a sequence of inorganic materials in optically thin layers (“microlayers”) on a substrate in a vacuum chamber.

Multilayer optical films have also been demonstrated by coextrusion of alternating polymer layers, each alternating pair known as an optical repeat unit. See, e.g., U.S. Pat. No. 3,610,729 (Rogers), U.S. Pat. No. 4,446,305 (Rogers et al.), U.S. Pat. No. 4,540,623 (Im et al.), U.S. Pat. No. 5,448,404 (Schrenk et al.), and U.S. Pat. No. 5,882,774 (Jonza et al.). In these polymeric multilayer optical films, polymer materials are used predominantly or exclusively in the makeup of the individual layers. Such films are compatible with high volume manufacturing processes and can be made in large sheets and roll goods. In some embodiments, at least one of the materials used in the alternating polymer layers is either polyethylene naphthalate or a copolymer that includes polyethylene terephthalate and polyethylene naphthalate. In some embodiments, at least one of the materials used in the layers capable of developing birefringence is polyethylene naphthalate or a copolymer of polyethylene naphthalate, polyethylene terephthalate, and any other monomer at a mol % less than 10%, with mol % based on the diacid monomer being 100%. In some applications, however, because polyethylene naphthalate may yellow after exposure to ultraviolet light—and/or because systems using polyethylene naphthalate may shift its reflectivity spectrum (as a function of wavelength) too strongly as a function of incidence angle, the birefringent layer or the multilayer reflector overall may not include any polyethylene naphthalate, and polyethylene terephthalate and copolymers thereof not including polyethylene naphthalate may be used instead.

Many materials and material sets are known and have been described in the art.

A multilayer optical film includes individual microlayers having different refractive index characteristics so that some light is reflected at interfaces between adjacent microlayers. The microlayers are sufficiently thin so that light reflected at a plurality of the interfaces undergoes constructive or destructive interference in order to give the multilayer optical film the desired reflective or transmissive properties. For multilayer optical films designed to reflect light at ultraviolet, visible, or near-infrared wavelengths, each microlayer generally has an optical thickness (a physical thickness multiplied by refractive index) of less than about 1 μm. The reflection band of a particular optical repeat unit (with an f-ratio of 50%, as described in more detail below) is centered around double the optical thickness of the optical repeat unit. Layers may be arranged generally as thinnest to thickest. In some embodiments, the arrangement of the alternating optical layers may vary substantially linearly as a function of layer count. These layer profiles may be referred to as linear layer profiles. In some embodiments, the thickness of the layers may be arranged monotonically. Generally, linear layer profiles are based on the overall shape of the layer arrangement, and minor or insignificant deviations from a linear layer profile would still be considered by a person having ordinary skill in the art as being a linear layer profile. In some embodiments, this may be referred to as a substantially linear layer profile. In some embodiments, the arrangement of the alternating optical layers may vary substantially according at a polynomial or power law. Thicker layers may be included, such as skin layers at the outer surfaces of the multilayer optical film, or protective boundary layers (PBLs) disposed within the multilayer optical films, that separate coherent groupings (“packets”) of microlayers. Skin layers are sometimes added which occurs after the feedblock but before the melt exits the film die.

The multilayer melt is then cast through a film die onto a chill roll in the conventional manner for polyester films, upon which it is quenched. The cast web is then stretched by at least one of a variety of possible processes to achieve birefringence in at least one of the optical layers, producing in many cases either a reflective polarizer or mirror film, as has been described in, for example, U.S. Patent Publication No. 2007/047080 A1, U.S. Patent Publication No. 2011/0102891 A1, and U.S. Pat. No. 7,104,776 (Merrill et al.). The films, having birefringence, may be referred to as multilayer birefringent optical films.

In some embodiments, the alternating materials include a birefringent layer (more specifically, a layer capable of developing stress-induced birefringence) and an isotropic layer (where, at least under the same processing conditions as the birefringent layer, the layer does not develop birefringence), where the material sets and processing conditions are selected so that the indices in the in-plane directions between the birefringent and the isotropic layer are different, while in the out-of-plane direction, the indices are similar or equal. For widely used materials, the birefringent layer will have a larger index of refraction than the isotropic layer. In some embodiments, the material sets and processing conditions are selected so that the in-plane indices of refraction are the same, or within 0.01 of each other for the birefringent layer. In some embodiments, the material sets and processing conditions are selected so that the in-place indices of refraction are each between 1.62 and 1.65, for the birefringent layer. In some embodiments, the material sets and processing conditions are selected so that the index of refraction along an out-of-plane direction is different by at least 0.05 from the index of refraction along both of two orthogonal in-plane directions, for the birefringent layer. In some embodiments, the material sets and processing conditions are selected so that the index of refraction along the out-of-plane direction is less than 1.53, for the birefringent layer.

The f-ratio, or the ratio of the optical thickness of high index birefringent layer 110 to the total optical thickness of a layer pair (including the low index isotropic layer) in some embodiments may be 50% or within 5% of 50%. In some embodiments, the f-ratio may be greater than 50%, for example, 60%, 65%, 70%, 75%, 80%, 85%, or even 90%. In some embodiments, the inverse f-ratio (e.g., 40% versus 60%) may have substantially equivalent optical performance. For more significant deviations from 50%, depending on the relative material cost of the high index birefringent layer and the low index isotropic layer (or, in some uncommon but available material sets, a low index birefringent layer such as syndiotactic polystyrene paired with a high index isotropic layer), a certain f-ratio versus its inverse may be chosen based on the material cost of making such a film, which, over large volumes, may be or become significant.

Manipulation of f-ratios in the design of multilayer reflectors described herein may allow for combinations of desirable features or tuneability: for example, the specific fraction of light of a certain wavelength reflected by a multilayer stack may be altered without significantly changing the overall film thickness or changing the number of layers, enabling a multilayer reflector over a variety of configurations. Films described herein may be thinner than 100 micrometers, thinner than 90 micrometers, thinner than 80 micrometers, thinner than 70 micrometers, thinner than 60 micrometers, thinner than 55 micrometers, thinner than 50 micrometers, thinner than 45 micrometers, thinner than 40 micrometers, or may even be thinner than 35 micrometers.

In some embodiments, the f-ratio and the thicknesses are tuned and configured together. For example, in some embodiments, the plurality of optical repeat units have a minimum optical thickness and an f-ratio such that the average transmission of unpolarized, normally incident light from 400 nm to 480 nm is greater than 40%. As described elsewhere, this may be tuned by altering the f-ratio such that the average transmission of unpolarized, normally incident light from 400 nm to 480 nm is greater than 50%, greater than 60%, greater than 70%, or greater than 80%.

Multilayer reflectors as described herein may also have high reflectivity across large portions of the visible spectrum (or any other desired spectrum or wavelength range). For example, in some embodiments, the plurality of optical repeat units are configured (e.g., have a thickness, index of refraction contrast, processing conditions, f-ratio) such that the average transmission of unpolarized normally incident light from 550 nm to 800 nm is less than 5%.

FIG. 2A is a side elevation cross-section of a layer pair showing an f-ratio near 50%. Layer pair 200A includes birefringent high index layer 210A and isotropic low index layer 220A having approximately the same optical thickness. FIG. 2B is a side elevation cross-section of a layer pair showing an f-ratio less than 50%. Layer pair 200B includes birefringent high index layer 210B having a smaller optical thickness than isotropic low index layer 220B. FIG. 2C is a side elevation cross-section of a layer pair showing an f-ratio greater than 50%. Layer pair 200C includes birefringent high index layer 210C having a larger optical thickness than isotropic low index layer 220C. The relative physical thickness ratios are exaggerated for ease of illustration.

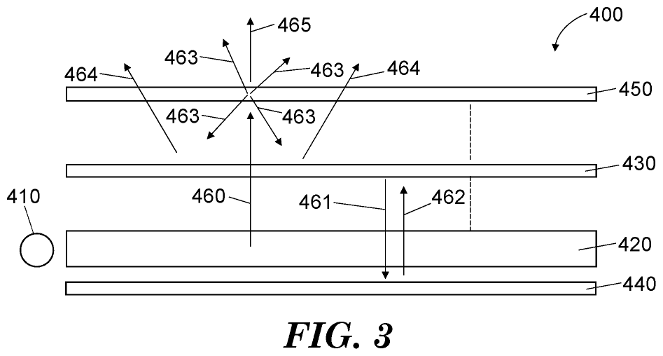

FIG. 3 is a side elevation schematic of the operational principles and configurations of an edge-lit backlight including the multilayer reflector with uniform left bandedge of FIG. 1. Backlight 400 include light source 410, light guide 420, multilayer reflector 430, back reflector 440, and downconverting layer 450. Dashed lines indicate that the layers are in optical communication, but may not necessarily be directly attached by lamination or other means. In some embodiments, adjacent films may be simply stacked on one another to preserve air gaps between those two films.

Light emitted from light source 410 is extracted from light guide 420 as light 460.

Light source 410 may be any suitable light source or combination of light sources. In many cases, light source 410 is or includes light emitting diodes (LEDs). Light source 410 is referred to in the singular, but may represent a bank or series of light sources. For example, light source 410 may be a series of LEDs extended along the axis into/out of the page. In some embodiments, light source 410 may include conventional LEDs (i.e., having a die size from about 150 μm to about 1 mm), mini LEDs (i.e., having a die size from about 30 μm to about 150 μm), or micro LEDs (i.e., having a die size from about 2 μm to about 30 μm). In some embodiments, light source 410 emit substantially white light. In some embodiments, certain of the components light source 410 emit light of different wavelengths that may together create white light. “White” light may refer to any suitable desirable color point that may be perceived as a viewer as white light and may be adjusted or calibrated depending on the application. In some embodiments, light source 410 may emit light in one or more of the ultraviolet range, the visible range, or the near-infrared range of the electromagnetic spectrum. In some embodiments, light source 410 may emit substantially blue light, with a peak between 400 nm and 500 nm or, more specifically, with a peak between 400 nm and 480 nm. Light source 410 may also be or include cold cathode fluorescent lights (CCFLs) or even, in some embodiments, incandescent light sources. The light sources and any corresponding injection, collimation, or other optics may be selected to provide any suitable wavelength or combination of wavelengths, polarizations, point spread distributions, and degrees of collimation.

Light guides such as light guide 420 are generally solid transparent optical components that transport light through total internal reflection and have carefully designed and arranged features or specific geometries to provide control over the extraction of light along its length and/or width. In these cases, it may be useful to think of each point on the emission surface of the lightguide (in the reference frame of FIG. 3, likely the top) as being a virtual source of a light distribution cone. The design and geometry of the lightguide (such as, for example, a wedge-shaped lightguide) and the shape and distribution of extractors may alter the shape or width of such light distribution cones. Certain extractor designs may be used to emit highly collimated light at a desired angle. Light guides are typically formed from transparent material that is easy to manufacture and form, such as by injection molding. Acrylic (poly(methyl methacrylate)) is commonly used due to its transparency, low inherent birefringence, and its ability to be readily formed into desired shapes through injection molding processes, but any other suitable polymer, copolymer or blend thereof might be used to form the light guide.

Light 460 is blue light, so it is substantially transmitted through multilayer reflector 430 without significant absorption or reflection. In some embodiments, transmission can be higher on-axis than for blue light incident on the multilayer reflector at an angle, creating a collimating effect. In some embodiments, a portion of light 460 may be reflected by multilayer reflector 430 in order to increase the areal uniformity of emitted light from backlight 400 (specifically, by allowing light to travel downguide instead of being predominantly transmitted near the launch edge). Reflected light 461 is transmitted back through light guide 420 and is reflected by back reflector 440. Back reflector 440 may be any suitable reflector, including a metal-coated or metallized film, a white (diffuse) plastic reflector, or even a multilayer optical reflector, such as Enhanced Specular Reflector (ESR) (available from 3M Company, St. Paul, Minn.). In some embodiments, particularly where thinness may be extremely important, back reflector 440 may have only layers that reflect blue light over an extended angular range or at all incident angles, allowing for a very thin reflector design. Redirected light 462 is then directed toward multilayer reflector 430 again and may be transmitted this cycle or be further recycled.

Turning again to transmitted light 460, the ray is next incident on downconverting layer 450. Downconverting layer includes dispersed or coated downconverting material.

Downconverting material, generally, is any material that absorbs a particular wavelength of light and reemits a second, less energetic (longer) wavelength of light. In some embodiments, the downconverting material may be or include a phosphor. In some embodiments, the downconverting material may be or include quantum dots. Downconverting layer 450 may be located at any point within the backlight or even within the display stack: in some embodiments, downconverting layer 450 may be attached to or integrated with a color filter array disposed on a liquid crystal panel.

After transmitted light 460 is incident on downconverting layer 450, at least a portion of transmitted light 460 is absorbed by downconverting material in order to be reemitted. In other words, transmitted light 460 and the downconverting material in downconverting layer 450 are selected and configured such that transmitted light 460 is pump light for the downconverting material in downconverting layer 450. Downconverting material randomly emits downconverted light 463 in all directions. Downconverted light 463 is equally likely to be emitted at useful angles for displays (for example, in a typical backlight and display construction and in the reference frame of FIG. 3, in the up direction) as it is to be emitted at non-useful angles (for example, in a typical backlight and display construction and in the reference frame of FIG. 3, back toward the lightguide and back reflector). However, multilayer reflector 430, in addition to working as a selective transmitted of blue light for transmitted light 460, is also a selective reflector of downconverted light 463 (for example, green or red light). Redirected downconverted light 464 is reflected back up at useful display angles and, because it is no longer pump light for the downconverting material of downconverting layer 450, is substantially transmitted and emitted toward the rest of the display not pictured in FIG. 4, along with the portion of transmitted light 460 not absorbed by downconverting layer 450, labelled as passed pump light 465. The configuration shown in FIG. 3, an edge-lit backlight, may be replaced with a direct-lit backlight in some configurations. In direct-lit configurations, the lightguide and edge-positioned light source would be replaced with an array of light sources located directly behind the other backlight film components. A diffuser, partial reflector, and/or reflector may be added for uniformity and efficiency.

In some embodiments, color uniformity, i.e. the lack of a color shift as a function of incidence angle and efficiency may be balanced by controlling the locations and the sharpness of the left and right bandedges, or the points where the reflector transitions from low transmission to higher transmission, on the short and long wavelength side, respectively. Hemispherical reflectivity, averaged over wavelengths of interest, is a simple measurable reflector characteristic that can indicate acceptable and excellent color and efficiency performance. For example, blue hemispheric reflectivity, defined as the average between 420 and 480 nm, and red-green hemispheric reflectivity, defined as the average between 520 and 650 nm, may be used. In some embodiments, blue hemispheric reflectivity is less than 55%. In some embodiments, blue hemispheric reflectivity is less than 50%. In some embodiments, red-green hemispheric reflectivity is greater than 97%. In some embodiments, red-green hemispheric reflectivity is greater than 98%. In some embodiments, red-green hemispheric reflectivity is greater than 99%. These hemispheric reflectivity measurements are affected by the location of the bandedges but also the slope of the bandedge—i.e., how quickly the spectrum transitions from low transmission to high transmission.

In some embodiments, the optical repeat units have a minimum optical thickness and an f-ratio such that the average transmission of unpolarized normally incident light from 400 nm to 480 nm is greater than 40%. In some embodiments, the optical repeat units are configured such that the average transmission of unpolarized normally incident light from 550 nm to 750 nm is less than 5%, or even less than 2%, or even less than 1%.

### EXAMPLES

### Calculations Method for Hemispherical Reflection Spectra (Rₕₑₘᵢ (λ))

Hemispheric reflection is defined as the intensity and solid-angle weighted average of the film reflectance R(θ,ϕ) where θ represents the polar angle and ϕ, represents the azimuthal angle relative to the plane of the film and where the illumination intensity, I(θ,ϕ), is assumed to be Lambertian. The ratio of the total flux of the reflected light to the total flux of the incident light for the wavelength range of interest yields the hemispheric reflectivity, Rₕₑₘᵢ(λ).

Rₕₑₘᵢ(λ) may be calculated as described in PCT Publication WO 2017/106096 A1 (Kivel et al.) from information on the layer thickness profiles of microlayers and the other layer elements of the optical film and from the refractive index values that are associated with each of the microlayers and other layers within the film. By using a 4×4 matrix-solving software application for the optical response of a multilayer film, both the reflection and transmission spectra can be calculated from the known layer thickness profile(s) and refractive index properties for the x-axis plane of incidence and for the y-axis plane of incidence and for each of p-polarized and s-polarized incident light. From this, Rₕₑₘᵢ (λ) may be calculated by use of the equations listed below:

$${R}_{hemi} ( λ ) = ( \frac{{R}^{x - axis} ( λ ) + {R}^{y - a x i s} ( λ )}{2} ) * ( 1 / {E}_{norm} ) , \\ where$$

$${R}^{x - axis} ( λ ) = \frac{1}{2} {\int }_{0}^{π / 2} {\{ {R}_{pp - x} ( θ , λ ) + {R}_{ss - x} ( θ , λ ) \}}^{*} E ( θ ) d θ , \\ {R}^{y - axis} ( λ ) = \frac{1}{2} {\int }_{0}^{π / 2} \{ {R}_{ss - y} ( θ , λ ) + {R}_{pp - y} ( θ , λ ) \} * E ( θ ) d θ , \\ and$$

$${E}_{norm} = {\int }_{0}^{π / 2} E ( θ ) d θ$$

$$where E ( θ ) is the intensity distribution .$$

Substantive agreement between measured and calculated profiles in, for example, Kivel et al., have validated that the computational technique captured the relevant physics of reflection from a broadband visible reflector, including the effects of absorptive losses on the detailed reflection spectra.

For purposes of reporting results from portions of the spectral response, the RₕₑₘᵢB_{avg}, defined as the average for 420-480 nm is reported for each example. Likewise, the RₕₑₘᵢGR_{avg}, defined as the average for 520-650 nm is reported for each example. The left bandedge (LBE) is defined as the point in the calculated hemispherical spectrum between blue and green portions where the measured % transmission equals 50% of the maximum transmission and L1 is defined by that wavelength where the left edge of the transmission spectrum intersects with maximum sample transmission. Likewise, the right bandedge (RBE) is defined as the point in the calculated hemispherical spectrum near 800 nm where the transmission equals 50% of the maximum transmission and L2 is that wavelength where the right edge of the transmission spectrum intersects with maximum sample transmission. Both the average wavelength for the left and right band edges as well as the slope of the transmission curve are important parameters for an optical solution robust to typical manufacturing variance. These data are reported in each of the following examples where model variation ranges of +/−10 nm of from center design point to simulate manufacturing variance based on caliper variation.

### EXAMPLES AND COMPARATIVE EXAMPLES

In these modeled examples, the following methodology was undertaken to measure the backlight unit (BLU) spectrum. For each condition, the BLU spectrum was computed using a two-stream approximation in a recycling model as follows: blue light was injected into a first recycling cavity lined with a back reflector on one side and the blue-pass reflector on the other. Blue light transmitted through the blue-pass mirror was transmitted into a second recycling cavity lined by the blue-pass mirror and a phosphor layer on one side, and a crossed prism film and reflecting polarizer (XBEF and DBEF, both available from 3M Company, St. Paul, Minn.) stack on the other. Blue light incident on the phosphor layer was partially absorbed and converted to green and red light with each pass. Total absorption and conversion was a function of the amount of recycling, which was modeled as a convergent infinite series. A similar calculation was conducted for green and red light such that the amount of light transmitted through the brightness enhancement stack was determined for all possible wavelengths comprising the final BLU spectrum. That spectrum formed the basis to compute performance characteristics such as intensity, brightness, white point coordinates and efficiency relative to the blue light emitted at the source.

The modeled BLU used for this particular set of examples consists of blue LEDs emitting at 450 nm, a back reflector assumed to have an 85% Lambertian reflectivity, a blue-pass multilayer optical film (MOF), a down-converting layer consisting of a Mitsui green phosphor emitting at 535 nm and a GE K2SiF6MnIV red phosphor emitting between 600 and 650 nm, and a traditional BLU recycling stack consisting of BEF4-GT and BEF4-GMv5 crossed prisms and an APFv3 reflective polarizer. Performance as a function of MOF design is reported as total system efficiency [lm/W], and color variations (Δu*, Δv*) calculated in the CIE 1976 (L*, u*, v*) color space.

We chose to parameterize the key spectral parameters of the MOF spectrum with the following parameters: L1, slope (LBE sharpness in % reflectivity per nm) and L2. For each design, we characterized the average system efficiency and the amplitude of u* and v* variation resulting from a +/−10 nm shift of the MOF spectrum typically associated with caliper variation in MOF manufacturing. Generally, results show that higher LBE sharpness (slope) improves manufacturing variation robustness for certain band edge locations. Ideally, Efficiency is maximized and greater than 50 [lm/W] for this analysis. Also ideally, color variations (Δu* and Δv*) with thickness variance are minimized.

TABLE 1
Calculated results for parameter ranges for L1 of 480 to 530 nm and L2 of 600 to 650 nm
for range of left band edge slopes.

| | L1 | LBE | L2 | RBE | Slope | Efficiency | | | | |
|---|---|---|---|---|---|---|---|---|---|---|
| Example | [nm] | [nm] | [nm] | [nm] | [%/nm] | [lm/W] | Δu* | Δv* | RₕₑₘᵢB_{avg} | RₕₑₘᵢGR_{avg} |
| CE-1 | 500 | 443 | 600 | 736 | 0.750 | 46.7 | 0.00326 | 0.0035 | 0.62224 | 0.95523 |
| CE-2 | 500 | 444 | 610 | 746 | 0.750 | 46.7 | 0.00375 | 0.00341 | 0.62083 | 0.96679 |
| CE-3 | 500 | 444 | 620 | 756 | 0.750 | 46.7 | 0.00363 | 0.00311 | 0.61917 | 0.97405 |
| CE-4 | 490 | 434 | 620 | 755 | 0.750 | 43.3 | 0.00293 | 0.0035 | 0.69063 | 0.97017 |
| CE-5 | 480 | 424 | 620 | 755 | 0.750 | 39.0 | 0.00265 | 0.00307 | 0.75942 | 0.96585 |
| CE-6 | 500 | 444 | 630 | 766 | 0.750 | 46.6 | 0.00213 | 0.00251 | 0.61729 | 0.97783 |
| CE-7 | 500 | 444 | 640 | 775 | 0.750 | 46.2 | 0.00064 | 0.00174 | 0.61525 | 0.97824 |
| EX-1 | 530 | 474 | 640 | 776 | 0.750 | 51.8 | 0.00552 | 0.00412 | 0.40537 | 0.98544 |
| EX-2 | 520 | 464 | 650 | 786 | 0.750 | 50.2 | 0.00143 | 0.00129 | 0.47168 | 0.98406 |
| EX-3 | 520 | 464 | 640 | 776 | 0.750 | 50.8 | 0.00262 | 0.0013 | 0.47275 | 0.98572 |
| EX-4 | 520 | 464 | 630 | 766 | 0.750 | 51.1 | 0.0054 | 0.00104 | 0.47371 | 0.98434 |
| EX-5 | 520 | 464 | 620 | 756 | 0.750 | 51.2 | 0.00715 | 0.00077 | 0.47452 | 0.97945 |
| EX-6 | 530 | 474 | 620 | 757 | 0.750 | 52.0 | 0.01031 | 0.0032 | 0.40638 | 0.97797 |
| EX-7 | 510 | 454 | 620 | 756 | 0.750 | 49.4 | 0.00485 | 0.00216 | 0.5467 | 0.97741 |
| EX-8 | 510 | 454 | 630 | 766 | 0.750 | 49.2 | 0.00319 | 0.00169 | 0.5454 | 0.98171 |
| EX-9 | 520 | 464 | 630 | 766 | 1.07 | 51.4 | 0.00271 | 0.00215 | 0.42858 | 0.98254 |
| EX-10 | 530 | 474 | 640 | 776 | 1.07 | 52.9 | 0.00178 | 0.00066 | 0.35281 | 0.98705 |
| EX-11 | 530 | 474 | 620 | 757 | 1.07 | 53.2 | 0.00625 | 0.00128 | 0.35363 | 0.98032 |
| EX-12 | 520 | 464 | 650 | 786 | 1.07 | 50.4 | 0.00089 | 0.0011 | 0.42682 | 0.98184 |
| EX-13 | 520 | 459 | 630 | 766 | 0.577 | 50.0 | 0.00901 | 0.00442 | 0.50765 | 0.98134 |
| EX-14 | 530 | 469 | 640 | 776 | 0.577 | 49.8 | 0.00771 | 0.00777 | 0.45058 | 0.97718 |
| EX-15 | 530 | 469 | 620 | 757 | 0.577 | 49.7 | 0.01262 | 0.00692 | 0.45162 | 0.96876 |
| EX-16 | 520 | 459 | 650 | 786 | 0.577 | 49.4 | 0.0046 | 0.005 | 0.5055 | 0.98165 |
| EX-17 | 520 | 464 | 610 | 747 | 0.750 | 51.0 | 0.00727 | 0.00092 | 0.47517 | 0.97096 |
| EX-18 | 510 | 454 | 610 | 746 | 0.750 | 49.3 | 0.00497 | 0.00239 | 0.54781 | 0.96955 |
| EX-19 | 520 | 464 | 600 | 737 | 0.750 | 50.8 | 0.00674 | 0.00073 | 0.47564 | 0.95881 |
| EX-20 | 510 | 454 | 600 | 737 | 0.750 | 49.2 | 0.00446 | 0.00239 | 0.54868 | 0.95805 |

We propose a figure of merit (FOM) that accounts for both Efficiency and color shifts with manufacturing variance such that:

FOM=[0.002+((Δu*)²+(Δv*)²)]×(Max Eff−Eff)²×100*(1.5−⅜(1/slope [%/nm])).

This FOM is chosen to provide a balance between minimizing color variation to limit of detection while maximizing efficiency. Design choices should seek to minimize this product of the color variation term and the efficiency term. The constant 0.002 in the color shift term is generally considered as a suitable rough estimate for minimum detectable color variation. The term Max Eff is the maximum efficiency calculated over the range of parameters explored for this analysis; in this case Max Eff is 55 [lm/W].

The resulting figure of merit for each example and comparative example is listed in Table 1 with FOM values of less than about 1.5 representing functional range of MOF design and FOM values of less than about 1.0 representing best MOF design performance.

| | L1 | LBE | L2 | RBE | Slope | Efficiency | | | |
|---|---|---|---|---|---|---|---|---|---|
| Example | [nm] | [nm] | [nm] | [nm] | [%/nm] | [lm/W] | Δu* | Δv* | FOM |
| CE-1 | 500 | 443 | 600 | 736 | 0.750 | 46.7 | 0.00326 | 0.0035 | 1.69 |
| CE-2 | 500 | 444 | 610 | 746 | 0.750 | 46.7 | 0.00375 | 0.00341 | 1.68 |
| CE-3 | 500 | 444 | 620 | 756 | 0.750 | 46.7 | 0.00363 | 0.00311 | 1.67 |
| CE-4 | 490 | 434 | 620 | 755 | 0.750 | 43.3 | 0.00293 | 0.0035 | 2.36 |
| CE-5 | 480 | 424 | 620 | 755 | 0.750 | 39.0 | 0.00265 | 0.00307 | 3.22 |
| CE-6 | 500 | 444 | 630 | 766 | 0.750 | 46.6 | 0.00213 | 0.00251 | 1.70 |
| CE-7 | 500 | 444 | 640 | 775 | 0.750 | 46.2 | 0.00064 | 0.00174 | 1.76 |
| EX-1 | 530 | 474 | 640 | 776 | 0.750 | 51.8 | 0.00552 | 0.00412 | 0.65 |
| EX-2 | 520 | 464 | 650 | 786 | 0.750 | 50.2 | 0.00143 | 0.00129 | 0.95 |
| EX-3 | 520 | 464 | 640 | 776 | 0.750 | 50.8 | 0.00262 | 0.0013 | 0.85 |
| EX-4 | 520 | 464 | 630 | 766 | 0.750 | 51.1 | 0.0054 | 0.00104 | 0.79 |
| EX-5 | 520 | 464 | 620 | 756 | 0.750 | 51.2 | 0.00715 | 0.00077 | 0.78 |
| EX-6 | 530 | 474 | 620 | 757 | 0.750 | 52.0 | 0.01031 | 0.0032 | 0.63 |
| EX-7 | 510 | 454 | 620 | 756 | 0.750 | 49.4 | 0.00485 | 0.00216 | 1.14 |
| EX-8 | 510 | 454 | 630 | 766 | 0.750 | 49.2 | 0.00319 | 0.00169 | 1.17 |
| EX-9 | 520 | 464 | 630 | 766 | 1.07 | 51.4 | 0.00271 | 0.00215 | 0.84 |
| EX-10 | 530 | 474 | 640 | 776 | 1.07 | 52.9 | 0.00178 | 0.00066 | 0.49 |
| EX-11 | 530 | 474 | 620 | 757 | 1.07 | 53.2 | 0.00625 | 0.00128 | 0.41 |
| EX-12 | 520 | 464 | 650 | 786 | 1.07 | 50.4 | 0.00089 | 0.0011 | 1.05 |
| EX-13 | 520 | 459 | 630 | 766 | 0.577 | 50.0 | 0.00901 | 0.00442 | 0.88 |
| EX-14 | 530 | 469 | 640 | 776 | 0.577 | 49.8 | 0.00771 | 0.00777 | 0.93 |
| EX-15 | 530 | 469 | 620 | 757 | 0.577 | 49.7 | 0.01262 | 0.00692 | 0.99 |
| EX-16 | 520 | 459 | 650 | 786 | 0.577 | 49.4 | 0.0046 | 0.005 | 0.98 |
| EX-17 | 520 | 464 | 610 | 747 | 0.750 | 51.0 | 0.00727 | 0.00092 | 0.81 |
| EX-18 | 510 | 454 | 610 | 746 | 0.750 | 49.3 | 0.00497 | 0.00239 | 1.15 |
| EX-19 | 520 | 464 | 600 | 737 | 0.750 | 50.8 | 0.00674 | 0.00073 | 0.86 |
| EX-20 | 510 | 454 | 600 | 737 | 0.750 | 49.2 | 0.00446 | 0.00239 | 1.18 |

From these results we observe that the best performance for figure of merit correlates well MOF filter value for RₕₑₘᵢB_{avg} of <0.55. Even better figure of merit is observed for a value of RₕₑₘᵢB_{avg} of <0.50. We also observe that good performance for figure of merit correlates well with MOF filter value for RₕₑₘᵢGR_{avg}>0.97. Even better figure of merit is observed for value of RₕₑₘᵢGR_{avg}>0.98. We also observe that for L1 and L2 are 520-530 nm and 630-640 nm, contrary to expectations, the overlap with the emission spectrum does not induce signification color; rather, color variation induced by the LBE is partially offset by the RBE, resulting in acceptable color variation and high efficiency.

Descriptions for elements in figures should be understood to apply equally to corresponding elements in other figures, unless indicated otherwise. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

What is claimed is:

1. A multilayer optical reflector, comprising:
a plurality of optical repeat units, each optical repeat unit having a total optical thickness and including a birefringent polymer and a second polymer and having a f-ratio, defined as the ratio of an optical thickness of the birefringent polymer to the total optical thickness of the optical repeat unit;
wherein the plurality of optical repeat units are configured such that a blue hemispheric reflectivity for unpolarized light averaged over the range from 420 to 480 nm is less than 55%; and
wherein the plurality of optical repeat units are configured such that a red-green hemispheric reflectivity for unpolarized light averaged over the range from 520 to 650 nm is greater than 97%.

2. The multilayer optical reflector of claim 1, wherein the plurality of optical repeat units are configured such that the blue hemispheric reflectivity for unpolarized light averaged over the range from 420 to 480 nm is less than 50%.

3. The multilayer optical reflector of claim 1, wherein the plurality of optical repeat units are configured such that the red-green hemispheric reflectivity for unpolarized light averaged over the range from 520 to 650 nm is greater than 98%.

4. The multilayer optical reflector of claim 1, wherein the plurality of optical repeat units are configured such that the blue hemispheric reflectivity for unpolarized light averaged over the range from 420 to 480 nm is less than 50%; wherein the plurality of optical repeat units are configured such that the red-green hemispheric reflectivity for unpolarized light averaged over the range from 520 to 650 nm is greater than 98%; and wherein the multilayer optical reflector is thinner than 50 micrometers.

5. The multilayer optical reflector of claim 1, wherein the plurality of optical repeat units does not include polyethylene naphthalate.

6. The multilayer optical reflector of claim 1, wherein the plurality of optical repeat units have a minimum optical thickness and an f-ratio such that the average transmission of unpolarized normally incident light from 400 nm to 480 nm is greater than 40%.

7. The multilayer optical reflector of claim 1, wherein the plurality of optical repeat units are configured such that the average transmission of unpolarized normally incident light from 550 nm to 750 nm is less than 5%.

8. The multilayer optical reflector of claim 1, wherein the plurality of optical repeat units are configured such that the average transmission of unpolarized normally incident light from 550 nm to 750 nm is less than 2%.

9. The multilayer optical reflector of claim 1, wherein for at least one layer of the plurality of optical repeat units, the index of refraction along two orthogonal in-plane directions are within 0.01 of each other.

10. The multilayer optical reflector of claim 9, wherein the index of refraction along two orthogonal in-plane directions are between 1.62 and 1.65.

11. The multilayer optical reflector of claim 1, wherein for at least one layer of the plurality of optical repeat units, the index of refraction along an out-of-plane direction is different by at least 0.05 from the index of refraction along both of two orthogonal in-plane directions.

12. The multilayer optical reflector of claim 9, wherein the index of refraction along the out-of-plane direction is less than 1.53.

13. An extended area light source, comprising:
a blue light source, wherein the blue light source has a maximum emitted wavelength between 420 nm and 480 nm;
a downconverting material, wherein the downconverting material absorbs light emitted from the blue light source and reemits light having a wavelength between 550 and 800 nm; and
the multilayer optical reflector of any of the preceding claims, wherein the multilayer optical reflector is disposed in an optical path between the blue light source and the downconverting material.

14. The extended area light source of claim 13, wherein the blue light source includes light emitting diodes.

15. The extended area light source of claim 13, wherein the downconverting material includes a phosphor.

16. The extended area light source of claim 13, wherein the downconverting material includes quantum dots.

17. The extended area light source of claim 13, further including a lightguide, disposed in an optical path between the blue light source and the downconverting material.

18. The extended area light source of claim 13, further including a back reflector, disposed in an optical path to reflect light reflected by the multilayer optical reflector.

19. The extended area light source of claim 13, wherein the downconverting material is within a downconverting film, and the downconverting film is within 10% of an area of the multilayer optical reflector.

20. The extended area light source of claim 13, wherein the downconverting material is within a color filter array.
